(19) United States
(12) Patent Application Publication
(10) Pub. No.: US 2003/0235412 A1
(43) Pub. Date: Dec. 25, 2003

(54) Optical ring network with decoupled read and write fibers

(75) Inventors: Emmanuel Dotaro, Verrieres Le Buisson (FR); Nicolas Le Sauze, Bures-Sur-Yvette (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/464,654

(22) Filed: Jun. 19, 2003

(30) Foreign Application Priority Data
Jun. 20, 2002 (FR) 02 07 628

(51) Int. Cl. H04B 10/08

(52) U.S. Cl. 398/33; 398/59

(57) ABSTRACT

An optical ring network comprises “active” first and second optical fibers (2 and 3), each connected via at least one of its two ends to an access node and optically coupled to stations (4), the fibers being dedicated respectively to transferring data to said stations and to transferring data from said stations. Each station (4) also has monitoring means (10) capable of determining whether the station is authorized to transmit data over the active second fiber (3), and the access node has transfer means arranged to transfer onto the active first fiber (2) any data conveyed by the active second fiber (3) and addressed to at least one of the stations.

The invention relates to the field of data transmission in optical ring networks.

Transmitting data by optical fiber presents certain advantages over traditional transmission by electric cable, in particular concerning the cost of the transport medium, data rate, attenuation, and electromagnetic interference.

Nevertheless, in point-to-point type optical transmission, the optical signals which encode the data being transported need to be converted into electrical signals each time they reach a node in the network so as to enable them to be used locally or relayed towards the next node, after being converted back into optical signals. Consequently, each node of that type of optical network needs to be fitted with an optical/electrical/optical (O/E/O) converter. This applies in particular to ring networks of the synchronous optical network (SONET) or of the synchronous digital hierarchy (SDH) types. The complexity of manufacturing such O/E/O converters and the difficulty in deploying them makes such optical ring networks expensive.

In an attempt to remedy that drawback, proposals have been to optimize the use of optical fibers by wavelength division multiplexing (WDM). That technique, now known as “dense” WDM (DWDM) enables a plurality of different wavelengths to be conveyed in the same fiber, thus increasing its passband, or in other words increasing the number of independent channels. One such WDM network is described in the article by S. S. Wagner et al. entitled “Multiwavelength ring networks for switch consolidation and interconnection” published in Discovering a New World of Communications, Chicago, Jun. 14-18, 1992, bound together with B0190700, Vol. 3, Proceedings of the International Conference on Communications, New York, IEEE, US, Vol. 45, June 1992 (1992-06-14), pp. 1171-1179, XPO10062090 ISBN: 0-7803-0599-X. That prior art network does not require add-and-drop electronic multiplexers since it includes passive optical couplers that are transparent at all of the wavelengths. One fiber pair is dedicated to transmission and another fiber pair is dedicated to reception. A switch situated at a presence point enables data to be transferred from one fiber to the other. That network is well adapted to setting up circuit communications, however it is not well adapted to sporadic data transmission.

An object of the invention is to remedy that drawback.

To this end, the invention provides an optical ring network comprising an access node, an active first optical fiber connected via at least one of its two ends to said access node, stations optically coupled to said first optical fiber, and an active second optical fiber connected via at least one of its two ends to said access node and optically coupled to each of the stations, said active second fiber being dedicated to conveying data transmitted from each station; said active first optical fiber being dedicated to conveying data to said stations; and said access node including transfer means arranged to transfer to the active first fiber any data that is conveyed by the active second fiber and that is addressed to at least one of the stations;

characterized in that:

the second fiber is shared by a plurality of stations capable of transmitting data packets on the same wavelength; and

each station has monitoring means suitable for determining whether said station is authorized to transmit a data packet on the active second fiber on a given wavelength.

By means of the invention, a single fiber can be shared by a plurality of stations transmitting data in the form of data packets. Each fiber is thus used much more efficiently, without there being any packet collisions. All of the data which a station seeks to transmit to the access node, or to at least one of the other stations, is injected into at least one active second fiber (which thus serves solely for “writing”) and travels to the access node, while all of the data going to stations, regardless of whether it comes from a station or an access node, is injected by the access node into at least one of the active first fibers (which thus serve exclusively for “reading”). A low-complexity network is thus obtained which is easy to deploy and which is low in cost.

The apparatus of the invention may include numerous additional characteristics which can be taken separately and/or in combination, and in particular:

at least one other active first optical fiber connected via at least one of its two ends to the access node, optically coupled to at least one of the stations, and dedicated to conveying data to the stations, the transfer means then being arranged to transfer to one of the active first fibers any data packets conveyed by an active second fiber and addressed to at least one of the stations;

at least one auxiliary first optical fiber associated with one of the active first optical fibers to receive all or part of the data for transferring to the stations either in the event of a failure of the associated active first fiber or in order to enable load to be shared between these two first fibers, the access node then having switch means capable of transferring the data for transmission onto the auxiliary first fiber or onto the associated active first fiber in the event of a failure being detected on one or other of the first fibers when active. The term “auxiliary first fiber” is used herein to mean a first fiber which at a given instant is not in use because the associated active first fiber is already in use (in which case the auxiliary fiber is a “backup” fiber), or which is used to carry part of the load as is the associated active first fiber. Consequently, the auxiliary fiber either comprises a backup first fiber dedicated exclusively to replacing a “main” first fiber, or else it comprises an active first fiber substantially identical to the associated active first fiber, in which case loading can be shared between these two fibers;

at least one other active second optical fiber connected via at least one of its two ends to the access node, optically coupled to at least one of the stations, and dedicated to conveying data transmitted from the stations, the transfer means then being arranged to transfer onto an active first fiber any data packets conveyed by said other active second fiber and addressed to at least one of the stations;

at least one auxiliary second optical fiber associated with at least one of the active second optical fibers to receive all or part of the data for conveying to the stations either in the event of a failure of the associated active second fiber or in order to share loading between these two active second fibers, the access node then including switch means capable of transferring the data for transmission onto the auxiliary second fiber or onto the associated active second fiber in the event of a failure being detected on one or other of the second fibers. The term “auxiliary” second fiber is used herein to mean a second fiber which at a given instant is not in use because the associated active second fiber is already in use (in which case it constitutes a “backup” fiber), or else which is used to carry part of the loading as is the associated active second fiber. Consequently, it comprises either a backup second fiber dedicated exclusively to replacing a “main” active second fiber, or else it comprises an active second fiber that is substantially identical to an associated active second fiber, with loading then being sharable between these two fibers;

the data travelling in the auxiliary first and second fibers travels in a direction opposite to the direction in which the data travels in the associated active first and second fibers;

the active or auxiliary first or second fibers convey data on a single wavelength;

the active first and second fibers and/or the auxiliary first and second fibers convey data on the same wavelength;

each station comprises: i) a receive module optically coupled to at least one of the active and auxiliary first fibers and capable of extracting therefrom data that is addressed to the station; and ii) a transmit module optically coupled to at least one of the active and auxiliary second fibers and capable of transmitting data over an active or an auxiliary second fiber when authorized by the monitoring means;

each station includes a memory, for example of the shared type, the memory being coupled to the transmit and receive modules and being capable of storing data that has been received or that is for transmission;

each station includes first coupling means for transferring data addressed to the station from the first fibers to the receive module, and second coupling means for optically coupling the transmit module to the second fibers and capable, when authorized by the monitoring means to transmit data stored in the memory over a second fiber, of coupling the transmit module to the second fiber;

receive modules comprise n receive elements coupled to the memory (e.g. n=4), and first coupling means, at least some of which comprise: i) n combiner first passive elements each coupled to one of the receive elements; ii) m separator second passive elements each coupled to one of the first fibers (where m is, for example, equal to, but could also be less than, the total number of active and auxiliary first fibers (for example m=4)), via passive optical couplers of the 2-to-1 type; and iii) n×m switch elements of the 1-to-1 (1:1) type such as semiconductor optical amplifiers (SOAs), each coupled to a first passive element and to a second passive element;

transmit modules comprising n′ transmit elements each as comprising a laser coupled to the memory (e.g. n′=4), and second coupling means, at least some of which comprise: i) n′ combiner first passive elements each coupled to one of said lasers; ii) m′ separator second passive elements each coupled to one of the second fibers (m′ being equal, for example, but possibly being less than, the total number of active and auxiliary second fibers (for example m′=4)), by means of passive optical couplers of the 1-to-2 type; and iii) n′×m′ switch elements of the 1-to-1 (1:1) type, such as SOAs, for example, each coupled to a first passive element and to a second passive element. Naturally, one laser may address a plurality of fibers and vice versa;

in a variant, receive modules comprise n receive elements coupled to said memory (e.g. n=4), and first coupling means, at least some of which comprise n passive couplers each connected to a respective one of the receive elements and to at least one of the first fibers;

in a variant, transmit modules comprising n′ transmit elements each comprising a laser coupled to the memory (e.g. n′=4), and second coupler means, at least some of which comprise n′ passive couplers each coupled to a respective transmit element and to at least one of the second fibers, possibly via n′ switch elements of the “1:1” type, such as SOAs, for example; and

monitoring modules comprising m′ photodiodes each coupled to a respective one of the second fibers (m′ being equal for example to the total number of active and backup second fibers (e.g. m′=4), but possibly being less than that), and each arranged to deliver a signal representative of the busy state of the associated second fiber.

The network of the invention is particularly, although not exclusively, adapted to transmitting data packets in the field of telecommunications.

Other characteristics and advantages of the invention appear on examining the following detailed description and the accompanying drawing, in which:

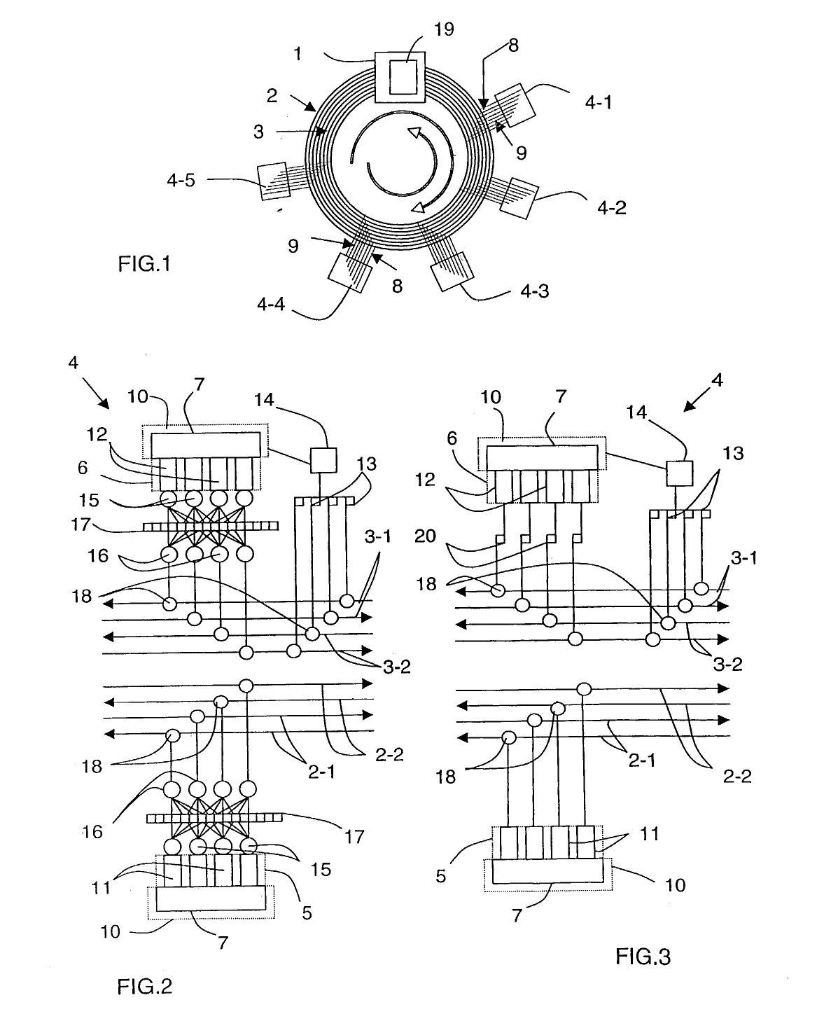

FIG. 1 is a diagram of an optical ring network of the invention;

FIG. 2 is a diagram of a station of the invention fitted with a first embodiment of the coupling means; and

FIG. 3 is a diagram of a station of the invention fitted with a second embodiment of the coupling means.

For the most part, the accompanying drawings are definitive in nature. Consequently, they can contribute not only to describing the invention, but also to defining it, where appropriate.

FIG. 1 shows an optical ring network comprising an access node or presence point 1 to which there are connected at least one of the two ends of optical fibers 2 and 3 for transmitting data optically, and a plurality of user stations 4-i (in this case i=1 to 5; this number not being limited in any way to five, it merely being a positive integer greater than one (1)), optically coupled to the fibers 2, 3, via coupling means 8, 9, which are described below with reference to FIGS. 2 and 3.

The ring is generally connected to another network, referred to as a “backbone” via the access node 1. The access node is preferably of the electronic type having memory means, such as electronic memories, for storing traffic, at least temporarily, and an electronic switch of the Ethernet or internet protocol (IP) type, fitted with O/E/O type converter means so as to be able to access all of the traffic circulating round the ring.

In the example, as shown more clearly in FIGS. 2 and 3, eight optical fibers 2, 3 are connected at least in part to the access node 1. More precisely, these eight fibers are grouped into two groups of four. A first group of four fibers 2 is dedicated to transferring data towards the stations 4-i (the term “reading” data is also used), while a group of four fiber 3 is dedicated to transmitting data from the stations 4-i (the term “writing” data is also used). These fibers are preferably arranged in the form of a bus. It is possible to envisage that both ends of each fiber 2, 3 are connected to the access node 1. However it is also possible to envisage firstly that a first end of the read fibers 2 is connected to the access node 1 while a second end is connected to the last station of the ring, secondly that a first end of the write fibers 3 is connected to the last station of the ring, while a second end thereof is connected to the access node 1.

The first group of fibers 2-q can be subdivided into q pairs each of two read fibers. In this example, q is equal to 2 (but q is any integer greater than or equal to 1). A first pair 2-1 comprises an “active” optical fiber since it is the fiber that is preferably used, together with an “auxiliary” optical fiber. In the example shown, the auxiliary fiber is a backup fiber since it is used only in the event of a break in the associated active fiber or in the event of a data transmission failure thereon. A second pair 2-2 likewise comprises an active optical fiber and an auxiliary optical fiber. In the example shown, the auxiliary fiber is also a backup fiber. This second pair 2-2 serves to double the data traffic capacity of the ring in reading.

The second group of fibers 3-r may be subdivided into r pairs each of two write fibers. In this example, r is equal to 2 (however r is any integer greater than or equal to 1). A first pair 3-1 comprises an active optical fiber and an auxiliary optical fiber (in this case a backup fiber). A second pair 3-2 likewise comprises an active optical fiber and an auxiliary optical fiber (in this case a backup fiber). This second pair 3-2 serves to double the data traffic capacity of the ring in writing.

In a first variant, each auxiliary fiber is identical to the associated active fiber, such that the load can be shared between the fibers in each pair, e.g. 50%-50%. Naturally, under such circumstances, in the event of one of the two fibers failing, the entire load is transferred onto the other fiber in the same pair. In a second variant, the number of auxiliary fibers provided is smaller than the number of active fibers. The auxiliary fibers are then for breakdown (backup) purposes or for load sharing, equally well for one or the other of the active fibers, which can themselves also be operated in load sharing mode. In other words, the network may have active fibers operating under full load or under reduced load (load shared with other active fibers with which they form pairs), or else with auxiliary fibers with which they form pairs or which they share with the other active fibers, and also backup auxiliary fibers with which they form pairs or which they share with other active fibers.

Preferably, the network is of the both-way type. In other words, data preferably travels in a first direction in the active fiber of a pair and in the opposite direction in the associated auxiliary (backup) fiber.

However that is merely one embodiment. In order to implement the invention, the minimum requirement is for an active first optical fiber 2 dedicated to transferring data towards the stations 4-i and an active second optical fiber 3 dedicated to carrying data transmitted by the stations 4-i. The transfer of data to the stations 4-i is often much more frequent than the transfer of data from the stations 4-i, so it is possible to envisage having a larger number of active read (or “first”) fibers 2-q than of active write (or “second”) fibers 3-r. It is also possible to envisage using more than two pairs of read fibers 2-q and/or of write fibers 3-r.

The backup fibers are not essential. They are there only to ensure continuity in data packet transmission in the event of a problem on the associated active fiber. Consequently, in a simplified network, it is possible to omit read and write backup fibers. Furthermore, it is possible to envisage having only one active fiber in reading 2 or writing 3 that is associated with a backup fiber, the other active fibers not being “duplicated”.

Each station 4-i has a receive module 5 dedicated to receiving or reading data travelling in the read fiber 2-q that is addressed to that station, and a transmit module 6 dedicated to transmitting or writing data via the write fibers 3-r.

The receive and transmit modules 5 and 6 are connected firstly to a memory 7, preferably comprising a first memory zone for received data and a second memory zone for data that is to be transmitted, secondly to means 8 or 9 for coupling to the read fibers 2-q or to the write fibers 3-r, and thirdly to a monitoring module 10. The memory 7 is preferably a shared memory.

In the example shown, the receive module 5 comprises four receive elements 11 for receiving data coming from respective read fibers 2-q. Also, in the example shown, the send module 6 comprises four send elements each comprising a laser 12 for writing data that is to be transmitted into a respective write fiber 3-r.

Preferably, all of the various receive elements 11 are substantially identical so as to be interchangeable in the event of any one of them breaking down. Also preferably, all of the transmit lasers 12 deliver a beam on a common wavelength, so as to be interchangeable in the event of any one of them breaking down. Still preferably, the receive and transmit wavelengths are identical (but that is not essential). As a result, all of the lasers are identical (and thus equivalent logically speaking) and all of the optical fibers 2, 3 are single frequency fibers and identical, thus considerably reducing the cost of the network.

In the stations 4-i, the data travelling in the read fibers 2 is read on-the-fly. Consequently, each station receives logic information, but only a fraction of the power, the remainder of the power remaining in the (active or auxiliary) fiber so as to provide communication with the other stations.

The monitoring module 10 of each station 4-i serves to govern the exchange of data between the fibers 2, 3 and the receive and transmit modules 5 and 6 via their respective coupling means 8 and 9. Its function is more particularly important on transmission since one of its functions is to analyze the traffic on the active write fibers 3-r so as to determine whether the station 4-i is free to transmit data towards the access node 1 on one of the active write fibers 3-r while avoiding collisions.

In order to enable the control module 10 to perform this function, each station 4-i is fitted with an observation device. In the example shown in FIGS. 2 and 3, the observation device comprises four photodiodes 13 each coupled to one of the write fibers 3-r and delivering electrical information to a controller 14 representing the traffic within the observed write fiber 3-r. For example, the photodiodes 13 scan the write fibers 3-r which are associated therewith using a technique such as optical carrier sense multiple access (Optical CSMA). The controller 14 delivers information to the control module 10 informing it whether transmission is possible and if so on which one of the fibers 3-r so as to enable it to configure the coupling means 9 (as described below) in preparation for possible transmission of data stored in the second zone of the shared memory 7.

In a variant, the network may include at least one additional wavelength dedicated to traffic monitoring, and associated for example with a procedure for issuing tokens, or else intended to specify which is the fiber to which coupling is to be performed.

FIG. 2 shows a first embodiment of the coupling means 8, 9. In this case, the receive module 5 and the transmit module 6 are respectively coupled to read fibers 2-q and write fibers 3-r by identical coupling means 8 and 9.

These coupling means 8 and 9 preferably comprise firstly n (in this case n=q=r=4 by way of illustration) first passive optical elements 15 for combining and/or separation purposes such as n-to-1 concentrators or 1-to-n separators, each coupled to a respective receive element 11 of the receive module 5 or to a respective laser 12 of the transmit module 6, and secondly m (in this case m=q=r=4 by way of illustration) second passive optical elements 16 for combining and/or separation purposes such as m-to-1 concentrators or 1-to-m separators, each coupled to a respective read fiber 2-q or write fiber 3-r via a passive optical coupler 18 such as a 2-to-1 separator or a 1-to-2 concentrator, and thirdly n groups of m optical switch elements 17 (in this case n×m=16), preferably of the “1-to-1” (1:1) type, such as SOAs each coupled to one of the n first passive elements 15 and to one of the m second passive elements 16.

This embodiment is particularly advantageous, in particular when all of the lasers 12 and the receive elements 11 are respectively identical and when a single wavelength is used for transmission and/or reception, insofar as it enables laser breakdowns to be handled without difficulty. This breakdown handling is preferably performed by the monitoring module in each station 4-i.

Naturally, one laser 12 or one receive element 11 may address a plurality of fibers, and vice versa.

FIG. 3 shows a second embodiment of the coupling means 8, 9.

In this case, each laser 12 or receive module 5 addresses a single read fiber 2-q or write fiber 3-r. Consequently, it is possible to envisage that the coupling means 8, 9 are mainly constituted by coupling optical fibers (coupler 18). However, that solution can be envisaged only when the lasers 12 exhibit rapid extinction, for example burst mode lasers. Otherwise, the laser emits continuously, either data or else “padding”, with the data needing to be forwarded and the padding to be eliminated. To eliminate padding, a passive optical switch 20 of the 1-to-1 type is provided between each laser 12 and each write fiber 3-r, for example an SOA, as shown in FIG. 3. There is no need to provide such passive switches between the receive modules 5 and the read fibers 2-q. Consequently, the coupling means 9 in this case preferably comprise n (in this case n=q=r=4) passive optical switches 20 of the 1-to-1 type, each connecting a respective one of the lasers 12 of the transmit module 6 to a respective write fiber 3-r via a coupling optical fiber 18, whereas in this case the coupling means 8 comprise n (in this case n=q=r=4) coupling optical fibers 18 each connecting a respective receive module 5 to a respective read fiber 2-q.

If it is desired to take laser breakdowns into account, it is preferable to duplicate each laser in each receive and transmit element.

This embodiment is particularly simple to deploy and makes it possible to reduce network costs considerably.

Naturally, it is possible to envisage station variants in which the receive modules 5 and the transmit modules 6 do not have coupling means of the same type. Thus, it is possible to envisage stations 4-i in which the transmit modules 6 are coupled to the write fibers 3-r by coupling means of the type described with reference to FIG. 2, and in which the receive modules 5 are coupled to the read fibers 2-q by coupling means of the type described with reference to FIG. 3. The opposite situation could also be provided. It is also possible to envisage that the transmit coupling means 9 and/or the receive coupling means 8 differ from one station to another depending in respective requirements.

Furthermore, the number of receive elements and/or transmit elements may vary from one station to another. This number is not necessarily equal to the number of write optical fibers or of read optical fibers. It depends on the type of coupling means used in each station. It is important to observe that it is not essential for each station to have access to all of the read and/or write fibers.

In order to manage data transmission between the various stations 4-i and between the stations and the access node 1, said access node 1 includes a transfer module 19. Depending on the selected arrangement, it either receives all of the data travelling in the read fibers 2-q and in the write fibers 3-r, or else it receives only all of the data travelling in the write fibers 3-r. Its main function is to transfer to the read fibers 2-q data transmitted by one of the stations on the write fibers 3-r and that is addressed to at least one of the other stations of the network. It also serves to transmit data between the various stations 4-i and the external backbone network when the access node is connected to such a backbone network, and conversely to transmit data from the external backbone network to the various stations 4-i.

The transfer module 19 is preferably of the electronic type and it thus continuously analyzes the final destinations of the data packets which arrive at the access node via the write fibers 3-r, and when the data packets relate to at least one of the stations, it determines the read fiber(s) 2-q on which it is going to transfer these data packets so that they can be read by the station(s) concerned on the ring network.

The operation of the optical ring network of the invention is particularly simple.

When a station that is optically coupled to the network in transparent manner seeks to transmit data to the access node and/or to at least one of the other stations of the network, its monitoring module 10 uses information supplied by the traffic observation device 13, 14 to determine whether it is possible to transfer said data over at least one of the write fibers 3-r. If this is not possible, then the data packets for transfer are made to wait. They remain in the second zone of the shared memory 7 until traffic allows them to be transmitted. In contrast, when the observation information shows that one of the write fibers 3-r can receive the packets that are to be transferred, the monitoring module 10 selects a transmit element 12 of the transmit module 6, configures the coupling means 9 (15-17, or 18), extracts the packets for transfer from the shared memory 7, and then communicates them to the selected transmit element so that it processes them and transmits them to the configured coupling means 9 which then merely need to apply them to the selected write fiber 3-r.

The data packets coming from the station thus travel in the selected write fiber 3-r and reach the access node 1 which forwards them to its transfer module 19. The transfer module determines whether the packets are addressed to one of the stations 4-i or only to the access node 1. If they are addressed only to the access node 1, it communicates them to the management means of the access node 1. Otherwise, it transfers the receive data packets onto one of the read fibers 2-q. The packets then travel along that fiber and can be picked up by the receive module 5 in each address station in order to be processed and/or used therein.

Furthermore, when the management means of the access node 1 seek to transmit data packets to at least one of the stations 4-i, they transmit the packets to the transfer module 19 so that it transfers them onto one of the read fibers 2-q.

When the network includes read and/or write backup fibers 2 and/or 3, detector means, e.g. of the OAM type, are provided for monitoring the traffic in the fibers so as to detect any transmission problems and immediately cause all of the data to be transferred onto the associated backup fiber in the event of a problem being detected. It is preferable for such detection means to form part of the transfer means 19 of the access node 1.

The invention is not limited to the network embodiments described above, purely by way of example, and it covers all variants that the person skilled in the art can envisage in the ambit of the following claims.

What is claimed is:

1/ An optical ring network comprising an access node (1), an active first optical fiber (2-1) connected via at least one of its two ends to said access node, stations (4-i) optically coupled to said first optical fiber (2-1), and an active second optical fiber (3-1) connected via at least one of its two ends to said access node (1) and optically coupled to each of the stations (4-i); said active second optical fiber (3-1) being dedicated to conveying data transmitted from each station; said active first optical fiber (2-1) being dedicated to conveying data to said stations; and said access node (1) including transfer means (19) arranged to transfer to the active first fiber (2-1) any data that is conveyed by the active second fiber (3-1) and that is addressed to at least one of the stations (4-i);
characterized in that:
the second fiber (3-1) is shared by a plurality of stations capable of transmitting data packets on the same wavelength; and
each station (4-i) has monitoring means (10) suitable for determining whether said station is authorized to transmit a data packet on the active second fiber (3-1) on a given wavelength.

2/ A network according to claim 1, characterized in that it includes at least one other active first optical fiber (2-2) connected via at least one of its two ends to said access node (1), optically coupled to at least one of the stations (4-i), and dedicated to transferring data towards the stations, said transfer means (19) being arranged to transfer to one of said active first fibers (2-1, 2-2), any data conveyed by an active second fiber (3-1, 3-2) and addressed to at least one of the stations (4-i).

3/ A network according to claim 1, characterized in that at least one of the active first optical fibers (2-1, 2-2) is associated with at least one auxiliary first optical fiber (2-1, 2-2) suitable for receiving all or part of the data for transferring towards the stations, and in that said access node (1) includes transfer means (19) suitable for transferring the data for transmission to said auxiliary first fiber or to the associated active first fiber in the event of a failure being detected on one of said associated active and auxiliary first fibers.

4/ A network according to claim 1, characterized in that it includes at least one other active second optical fiber (3-2) connected via at least one of its two ends to said access node (1), optically coupled to at least one of the stations (4-i) and dedicated to conveying data transmitted from the stations, said transfer means (19) being arranged to transfer to an active first fiber (2-1, 2-2) any data conveyed by said other active second fiber (3-2) and addressed to at least one of the stations.

5/ A network according to claim 3, characterized in that at least one of said active second optical fibers (3-1, 3-2) is associated with at least one auxiliary second optical fiber suitable for receiving all or part of the data transmitted from the stations, and in that said access node (1) includes transfer means (19) suitable for transferring the data for transmission onto the auxiliary second fiber or onto the associated active second fiber in the event of a failure being detected on one of said auxiliary and active second fibers.

6/ A network according to claim 3, characterized in that in the auxiliary first and second fibers, data travels in a direction opposite to the direction in which data travels in the associated active first and second fibers.

7/ A network according to claim 1, characterized in that each active or auxiliary first or second fiber (2-1, 2-2; 3-1, 3-2) is arranged to transmit on a single wavelength.

8/ A network according to claim 5, characterized in that the active first and second fibers (2-1, 2-2; 3-1, 3-2) and/or the auxiliary first and second fibers (2-1, 2-2; 3-1, 3-2) transmit data on the same wavelength.

9/ A network according to claim 3, characterized in that each station (4-i) comprises: i) a receive module (5) optically coupled to at least one of the active and auxiliary first fibers (2-1, 2-2) and arranged to extract therefrom data addressed to the station; and ii) a transmit module (6) optically coupled to at least one of the active and auxiliary second fibers (3-1, 3-2) and arranged to transmit data over an active or auxiliary second fiber in the event of being authorized by said monitoring means (10).

10/ A network according to claim 9, characterized in that each station (4-i) includes a memory (7) coupled to said transmit and receive modules (6 and 5) and suitable for storing received data and data for transmission.

11/ A network according to claim 10, characterized in that each station (4-i) includes first coupling means (8) suitable for transferring data addressed to the station from the first fibers (2) to the receive module (5), and second coupling means (9) for providing optical coupling between the transmit module (6) and said second fibers (3) and suitable, in the event of being authorized by said monitoring means (10) to transmit data stored in the memory (7) over a second fiber (3) for coupling said transmit module (6) to said second fiber (3).

12/ A network according to claim 11, characterized in that each receive module (5) comprises n receive elements (11) each coupled to said memory (7), and in that at least some of said first coupling means (8) comprise: i) n combiner first passive elements (15) each coupled to one of said receive elements (11); ii) m separator second passive elements (16) each coupled one of said first fibers (2), m being less than or equal to the total number of active and auxiliary second fibers (2); and iii) n×m switch elements (17) each coupled to a first passive element (15) and to a second passive element (16).

13/ A network according to claim 12, characterized in that each separator second passive element (16) is coupled to an active first fiber or to an auxiliary first fiber via a passive optical coupler (18) of the 2-to-1 type.

14/ A network according to claim 11, characterized in that each transmit module (6) comprises n′ transmit elements each comprising a laser (12) coupled to said memory (7), and in that at least some of said second coupling means (9) comprise: i) n′ combiner first passive elements (15) each coupled to one of said lasers (12); ii) m′ separator second passive elements (16) each coupled to one of said second fibers (3), m′ being less than or equal to the total number of active and auxiliary second fibers (3); and iii) n′×m′ switch elements (17) each coupled to a first passive element (15) and to a second passive element (16).

15/ A network according to claim 14, characterized in that each separator second passive element (16) is coupled to an active second fiber or an auxiliary second fiber via a passive optical coupler (18) of the 1-to-2 type.

16/ A network according to claim 11, characterized in that each receive module (5) comprises n receive elements (11) each coupled to said memory (7), and in that at least some of said first coupling means (8) comprise n passive optical couplers (18) of the 2-to-1 type each coupled to one of said receive elements (11) and to one of said active and auxiliary first fibers (2).

17/ A network according to claim 11, characterized in that each transmit module (6) comprises n transmit elements each comprising a laser (12) coupled to said memory (7), and in that at least some of said second coupling means (9) comprise n passive optical couplers (18) of the 1-to-2 type each coupled to one of said lasers (12) and to one of said active and auxiliary second fibers (3).

18/ A network according to claim 17, characterized in that each passive optical coupler (18) is coupled to a laser (12) via a switch element (20) of the “1:1” type.

19/ A network according to claim 1, characterized in that each monitoring module (10) comprises m′ photodiodes (13) each coupled to one of said second fibers (3), m′ being equal to the total number of active and auxiliary second fibers, and each arranged to deliver a signal representative of the busy state of the associated second fiber.
